(19) United States
(12) Patent Application Publication
(10) Pub. No.: US 2026/0177737 A1
(43) Pub. Date: Jun. 25, 2026

(54) IMPROVED EDGE BLACKENING FOR WAVEGUIDE EYEPIECES FOR USE WITH VIRTUAL AND AUGMENTED REALITY DISPLAY SYSTEMS

(71) Applicant: Magic Leap, Inc., Plantation, FL (US)

(72) Inventors: Vikramjit SINGH, Pflugerville, TX (US); Frank Y. XU, Austin, TX (US); Arturo Manuel MARTINEZ, Jr., Austin, TX (US); Marlon Edward MENEZES, Austin, TX (US)

(73) Assignee: Magic Leap, Inc., Plantation, FL (US)

(21) Appl. No.: 19/126,927

(22) PCT Filed: Nov. 3, 2023
(86) PCT No.: PCT/US2023/078720

§ 371 Date: May 2, 2025

Related U.S. Application Data
(60) Provisional application No. 63/382,362, filed on Nov. 4, 2022.

(51) Int. Cl. F21V 8/00; G02B 6/138; G02B 27/00; G02B 27/01

(52) U.S. Cl. CPC G02B 6/0076; G02B 6/138; G02B 27/0081; G02B 27/0172

(57) ABSTRACT

Improved stacked waveguide assemblies, and methods of making the same. The stacked waveguide assemblies include a plurality of waveguides stacked together and configured to transmit image information to a user's eye. Each of the waveguides is bonded to adjacent waveguides using a stack adhesive applied between the adjacent waveguides proximate an edge of each waveguide. A thin blackening edge layer is applied around the edge of each waveguide and is configured to absorb substantially all visible light bouncing off the edge of each respective waveguide. This design improves image contrast without affecting image sharpness.

### CROSS-REFERENCE TO RELATED APPLICATIONS

This application claims the benefit of priority to U.S. Provisional Patent Application Ser. No. 63/382,362, entitled “IMPROVED EDGE BLACKENING FOR WAVEGUIDE EYEPIECES FOR USE WITH VIRTUAL AND AUGMENTED REALITY DISPLAY SYSTEMS,” and filed on Nov. 4, 2022. The contents of the foregoing application is hereby expressly incorporated by reference for all purposes.

### FIELD OF THE INVENTION

The present disclosure relates to virtual reality and augmented reality imaging and visualization systems, and more particularly, to improved edge blackening for waveguide eyepieces used in display systems for virtual reality and/or augmented reality systems.

### BACKGROUND

Modern computing and display technologies have facilitated the development of systems for so called “virtual reality” (VR) or “augmented reality” (AR) and/or “mixed-reality” (MR) experiences, wherein digitally reproduced images or portions thereof are presented to a user in a manner wherein they seem to be, or may be perceived as, real. A virtual reality, or “VR,” scenario typically involves presentation of digital or virtual image information without transparency to actual real-world visual input. An augmented reality, or “AR,” scenario typically involves presentation of digital or virtual image information as an augmentation to visualization of the actual world around the user. A mixed reality scenario is a version of an AR scenario, except with more extensive merging of the real world and virtual world in which physical objects in the real world and virtual objects may co-exist and interact in real-time. As used herein, the terms “extended reality” and “XR” are used to refer collectively to any of VR, AR and/or MR. In addition, the term “AR” means either, or both, AR and MR.

For example, referring to FIG. 1, an augmented reality scene (4) is depicted wherein a user of an AR technology sees a real-world park-like setting (6) featuring people, trees, buildings in the background, and a concrete platform (1112). In addition to these items, the user of the AR technology also perceives that he “sees” a robot statue (1110) standing upon the real-world platform (1112), and a cartoon-like avatar character (2) flying by which seems to be a personification of a bumble bee, even though these elements (2, 1110) do not exist in the real world. As it turns out, the human visual perception system is very complex, and producing a VR or AR technology that facilitates a comfortable, natural-feeling, rich presentation of virtual image elements amongst other virtual or real-world imagery elements is challenging.

There are numerous challenges when it comes to presenting 3D virtual content to a user of an XR system. A central premise of presenting 3D content to a user involves creating a perception of multiple depths. In other words, it may be desirable that some virtual content appear closer to the user, while other virtual content appears to be coming from farther away. Thus, to achieve 3D perception, the XR system should be configured to deliver virtual content at different focal planes relative to the user.

In order for a 3D display to produce a true sensation of depth, and more specifically, a simulated sensation of surface depth, it is desirable for each point in the display's visual field to generate the accommodative response corresponding to its virtual depth. If the accommodative response to a display point does not correspond to the virtual depth of that point, as determined by the binocular depth cues of convergence and stereopsis, the human visual system may experience an accommodation conflict, resulting in unstable imaging, harmful eye strain, headaches, and, in the absence of accommodation information, almost a complete lack of surface depth.

Therefore, there is a need for improved technologies to implement 3D displays that resolve these and other problems of the conventional approaches. The devices, systems and techniques described herein are configured to work with the visual configuration of the typical human to address these challenges.

### SUMMARY

Embodiments of the present invention are directed to designs for, and methods of making, an improved stacked waveguide assembly for an eyepiece for use with an XR display system. More specifically, disclosed herein are new eyepiece designs having improved edge blackening for use in XR display systems having improved performance over previous waveguide and eyepiece designs. The presently disclosed eyepiece designs include innovative edge blackening and stacking architecture for an eyepiece waveguide stack which improves the functional performance of the eyepiece, such as improving the virtual image contrast by maximizing the absorption of light bouncing off the edges of the waveguide, rather than being propagated through total internal reflection (TIR).

Accordingly, one embodiment disclosed herein is directed to a stacked waveguide assembly for an eyepiece for use with an XR display system. The stacked waveguide assembly includes a plurality of waveguides stacked together and configured to transmit image information to a user's eye. Each of the waveguides is bonded to adjacent waveguides using a stack adhesive applied between the adjacent waveguides proximate an edge of each waveguide. The waveguide assembly includes a thin blackening edge layer applied onto and/or around the edge of each waveguide and configured to absorb substantially all visible light bouncing off the edge of each respective waveguide.

In another aspect, the stacked waveguide assembly may further include a perimeter bond applied over the blackening edge layer. In still another aspect, the perimeter bond adheres the stacked waveguide assembly to a frame of an eyepiece for use with an XR display system. In yet another aspect, the perimeter bond comprises a color-absorbing adhesive.

In another aspect, the blackening edge layer comprises carbon black pigments. The pigments may be 30 nm in diameter or less. In other aspects, the blackening edge layer may be applied using a fast drying surfactant, such as methanol, ethanol, isopropanol, or the like. In additional aspects, the blackening pigment can also comprise of a mixture of various pigment or dyes which can block varying wavelengths of light where the sum of all the color blocking agents block light from 400 nm to 800 nm wavelengths. For example, the dyes and pigments may include Carbon black (size range 5 nm˜500 nm), Rhodamine B, Tartarzine, chemical dyes from Yamada Chemical Co., Ltd., SUNFAST pigments from SunChemical (e.g., Green 36, Blue, Violet 23, etc.) In another aspect, the stack adhesive comprises a color-absorbing adhesive. In additional aspects, the stack adhesive and/or perimeter bond may include a pre-polymer material.

In another aspect, the pre-polymer can include a resin material, such an epoxy vinyl ester. In still another aspect, the pre-polymer material is dispensible using inkjetting, a syringe pump, or spray atomization. In additional aspects, the pre-polymer material may include dye or pigment configured to absorb all or a selected portion of visible light. In another aspect, the dye or pigment may be black so as to absorb all visible wavelengths of light.

In another aspect, at least a portion of the edge of the waveguides where the blackening edge layer is applied has a roughened surface. Up to the entire surface of the edge surface where the blackening edge layer is applied may have a roughened surface, including the external edge surface, top surface and bottom surface of each waveguide (e.g., an outer portion of the top surface and bottom surface extending proximate the external edge surface).

Another embodiment disclosed herein is directed to a method of making any of the stacked waveguide assemblies disclosed herein. A plurality of waveguides are stacked together such that the stacked waveguides are configured to transmit image information to a user's eye. Each of the waveguides is bonded to adjacent waveguides using a stack adhesive applied between the adjacent waveguides proximate an edge of the waveguides. A thin blackening edge layer is applied onto and/or around the edge of each waveguide such that the blackening edge layer absorbs substantially all visible light bouncing off the edge of each respective waveguide.

In another aspect, the method of making the stacked waveguide assembly may further include applying a perimeter bond applied over the blackening edge layer. In still another aspect, the perimeter bond adheres the stacked waveguide assembly to a frame of an eyepiece for use with an XR display system. In yet another aspect, the perimeter bond comprises a color-absorbing adhesive.

In additional aspects, the method may include any combination of one or more of the additional aspects and features of the stacked waveguide assembly embodiment, as described herein.

Another embodiment disclosed herein is directed to an eyepiece for an XR display system for delivering XR content to a user. The eyepiece comprises any of the stacked waveguide assemblies disclosed herein to receive light associated with one or more frames of image data and direct the light to the user's eyes. The eyepiece is configured to receive light associated with one or more frames of image data from an image-generating source, such as a fiber scanning device (FSD), high-resolution liquid crystal display (“LCD”) system, a backlighted ferroelectric panel display, a higher-frequency DLP system, or the like, and direct the light to the user's eyes.

Another embodiment disclosed herein is directed to an XR display system for delivering extended reality content to a user. The XR display system comprises an image-generating source to provide one or more frames of image data, a light modulator to transmit light associated with the one or more frames of image data, and an eyepiece comprising any of the stacked waveguide assemblies disclosed herein to receive light associated with one or more frames of image data and direct the light to the user's eyes.

In additional aspects, the XR display system may include any combination of one or more of the additional aspects and features of the stacked waveguide assembly embodiments, as described herein.

Another embodiment disclosed herein is directed to an XR system for generating and displaying XR content to a user. The XR system comprises a computer having a computer processor, memory, a storage device, and a software application(s) stored on the storage device and executable to program the computer to perform operations enabling the augmented reality system. The XR system includes an XR display system. The XR display system may be any suitable display system, such as XR headset having a display for displaying 3D virtual images (i.e., XR images). For example, the XR headset may include a frame structure configured to be worn on the head of a user. The frame structure carries an image-generating source to provide one or more frames of image data, a light modulator to transmit light associated with the one or more frames of image data, and an eyepiece comprising any of the stacked waveguide assemblies disclosed herein to receive light associated with one or more frames of image data and direct the light to the user's eyes.

In additional aspects, the XR display system may include any combination of one or more of the additional aspects and features of the stacked waveguide assembly embodiments, as described herein.

Additional and other objects, features, and advantages of the invention are described in the detail description, figures and claims.

### BRIEF DESCRIPTION OF THE DRAWINGS

The drawings illustrate the design and utility of various embodiments of the present disclosure. Note that the figures are not drawn to scale, and that elements of similar structures or functions are represented by like reference numerals throughout the figures. To better appreciate how to obtain the above-recited and other advantages and objects of various embodiments of the disclosure, a more detailed description of the present disclosures briefly described above will be rendered by reference to specific embodiments thereof, which are illustrated in the accompanying drawings. Understanding that these drawings depict only typical embodiments of the disclosure and are not therefore to be considered limiting of its scope, the disclosure will be described and explained with additional specificity and detail through the use of the accompanying drawings in which:

FIG. 1 illustrates a user's view of augmented reality (AR) through a wearable AR user device, in one illustrated embodiment.

FIG. 2 illustrates a conventional stereoscopic 3-D simulation display system for an XR system.

FIG. 3 illustrates an improved approach to implement a stereoscopic 3-D simulation display system for an XR system according to some embodiments disclosed herein.

FIGS. 4A-4D illustrate various systems, subsystems, and components for addressing the objectives of providing a high-quality, comfortably-perceived display system for human XR.

FIG. 5 illustrates a plan view of an example configuration of an XR system utilizing an improved diffraction structure, according to some embodiments disclosed herein.

FIG. 6 illustrates a stacked waveguide assembly for use in an XR display system.

FIG. 7 illustrates a DOE (diffractive optical element) for use in a display system, according to some embodiments disclosed herein.

FIGS. 8 and 9 illustrate example diffraction patterns for a DOE resulting in different exit beams directed toward the eye, according to some embodiments.

FIGS. 10 and 11 illustrate two stacked waveguides into which a beam is injected.

FIG. 12 illustrates a stack of waveguides.

FIG. 13A is schematic illustration of an embodiment of a previously disclosed stacked waveguide assembly.

FIG. 13B is a schematic illustration of stacked waveguide assembly according to one embodiment disclosed herein.

FIG. 14 is a table showing a comparison of the Image ANSI contrast from an RGB (red green blue) stack for each R G B color waveguide for various stack architectures.

FIG. 15 is a graph showing examples of transmission curves of the visible spectrum at 0 degrees incidence for four different types of adhesives used for the stack adhesive material and perimeter bond.

FIG. 16 is a schematic illustration of a stacked waveguide assembly having a roughened edge surface, according to another embodiment disclosed herein.

FIG. 17A is a schematic illustration of one of the waveguides of the stacked waveguide assembly of FIG. 16 showing the roughened edge surface before application of the edge blackening.

17B is a schematic illustration of one of the waveguides of the stacked waveguide assembly of FIG. 16 showing the roughened edge surface after application of the edge blackening.

FIG. 18A is a schematic illustration of one of the waveguides of the stacked waveguide assembly of FIG. 16 showing the roughened edge surface on the top and/or bottom edge gap before application of the edge blackening.

FIG. 18B is a schematic illustration of one of the waveguides of the stacked waveguide assembly of FIG. 16 showing the roughened surface on the top and or bottom edge gap surface after application of the edge blackening.

FIG. 19 is a magnified view of a portion of the roughened edge surface of the waveguides of FIGS. 16-18B.

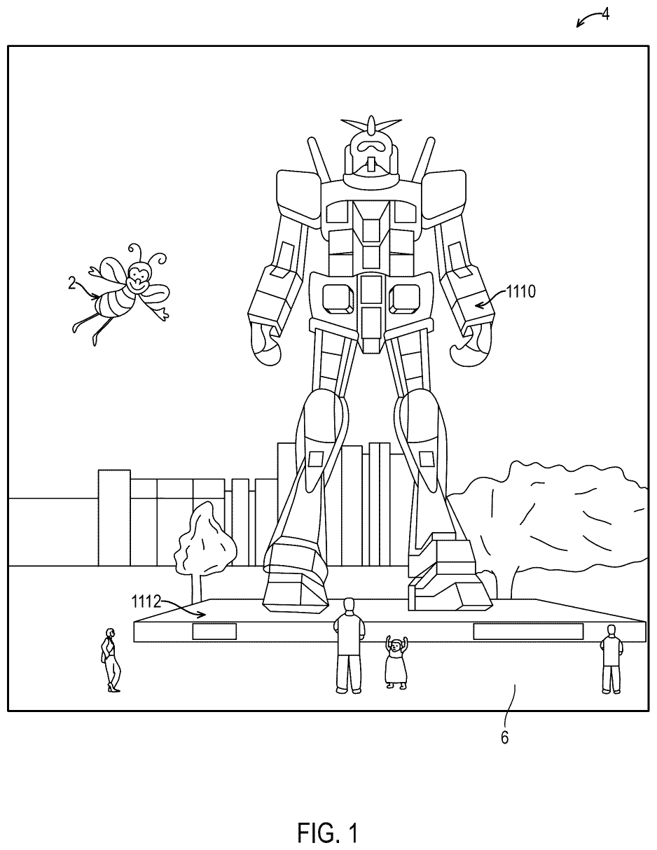

### DETAILED DESCRIPTION

The following describes various embodiments of improved waveguide assemblies for eyepieces used for extended reality (XR) display systems and XR systems for delivering extended reality content to a user. The stacked waveguide assemblies incorporate innovative edge blackening and stacking architecture which improves the functional performance of the eyepiece, including improving the virtual image contrast by maximizing the absorption of light bouncing off the edges of the waveguide, rather than being propagated through the waveguide via TIR.

### Display Systems According to Some Embodiments

This portion of the disclosure describes example display systems that may be used in conjunction with the improved stacked waveguide assemblies disclosed herein.

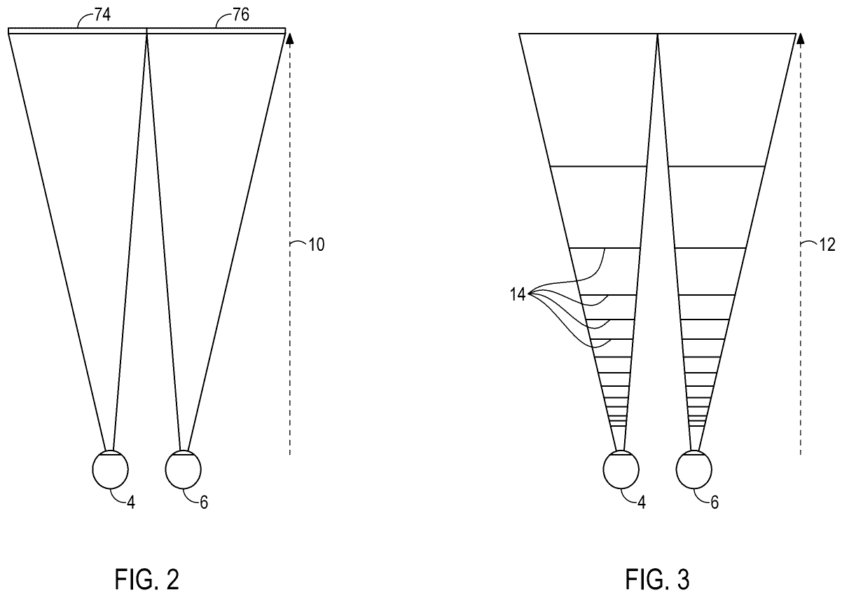

FIG. 2 illustrates a conventional stereoscopic 3-D simulation display system for an XR system. The display system typically has a separate display 74 and 76 for each eye (4 and 6), respectively, at a fixed radial focal distance (10) from the eye. This conventional approach fails to take into account many of the valuable cues utilized by the human eye and brain to detect and interpret depth in three dimensions, including the accommodation cue.

In fact, the typical human eye is able to interpret numerous layers of depth based upon radial distance, e.g., the human eye is able to interpret approximately 12 layers of depth. A near field limit of about 0.25 meters is about the closest depth of focus; a far-field limit of about 3 meters means that any item farther than about 3 meters from the human eye receives infinite focus. The layers of focus get more and more thin as one gets closer to the eye; in other words, the eye is able to perceive differences in focal distance that are quite small relatively close to the eye, and this effect dissipates as objects fall farther away from the eye. At an infinite object location, a depth of focus/dioptric spacing value is about ⅓ diopters.

FIG. 3 illustrates an improved approach to implement a stereoscopic 3-D simulation display system for use in an AR system according to some embodiments of the invention. In this approach, two complex images are displayed, one for each eye (4 and 6), with various radial focal depths (12) for various aspects (14) of each image utilized to provide each eye with the perception of three dimensional depth layering within the perceived image. Since there are multiple focal planes (e.g., 12 focal planes) between the eye of the user and infinity, these focal planes, and the data within the depicted relationships, may be utilized to position virtual elements within an augmented reality scenario for a user's viewing, because the human eye is constantly sweeping around to utilize the focal planes to perceive depth. While this figure shows a specific number of focal planes at various depths, it is noted that an implementation of the invention may use any number of focal planes as necessary for the specific application desired, and the invention is therefore not limited to devices having only the specific number of focal planes shown in any of the figures and/or described in the present disclosure.

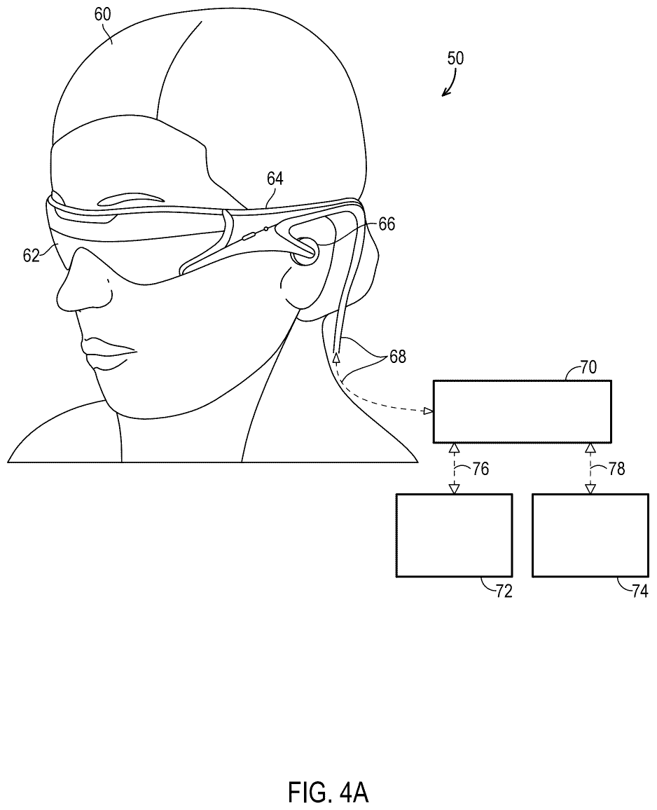

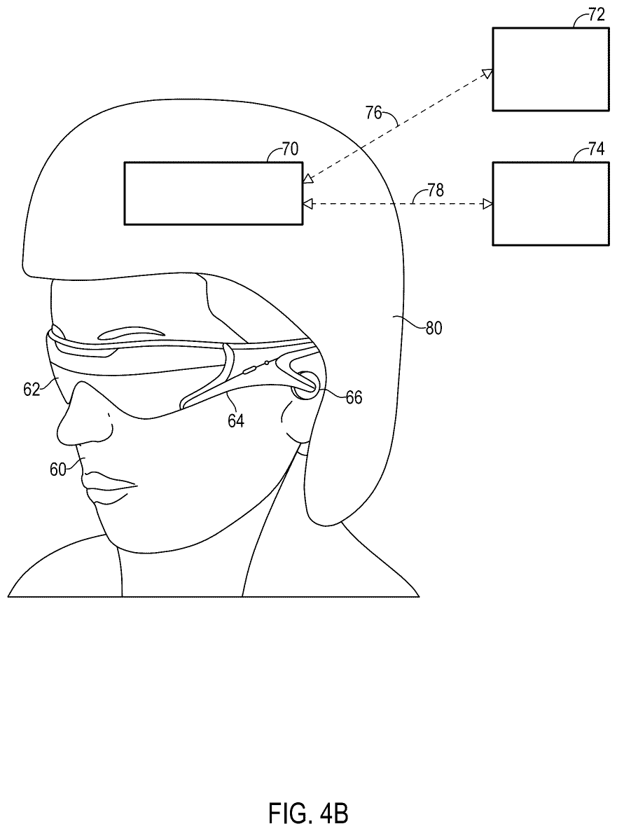

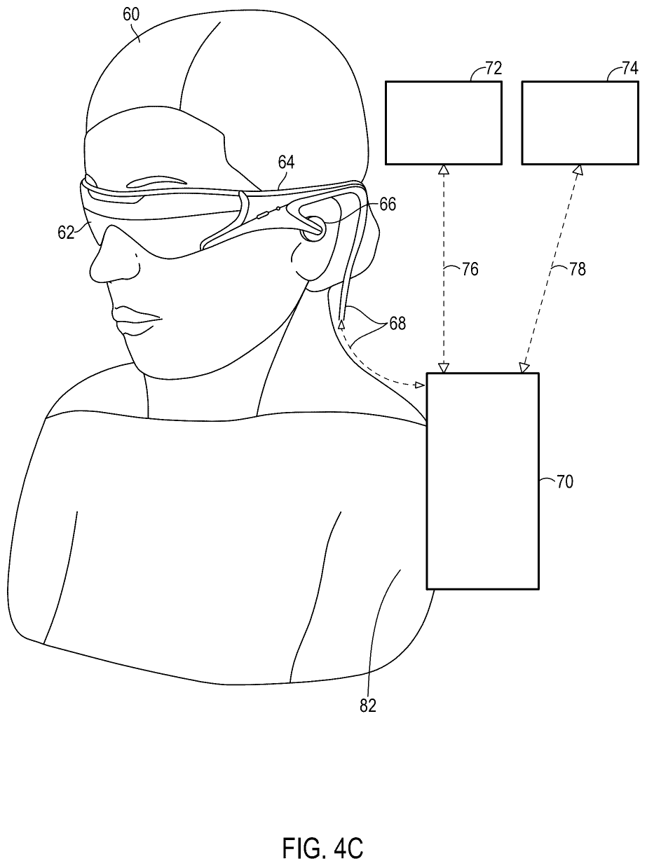

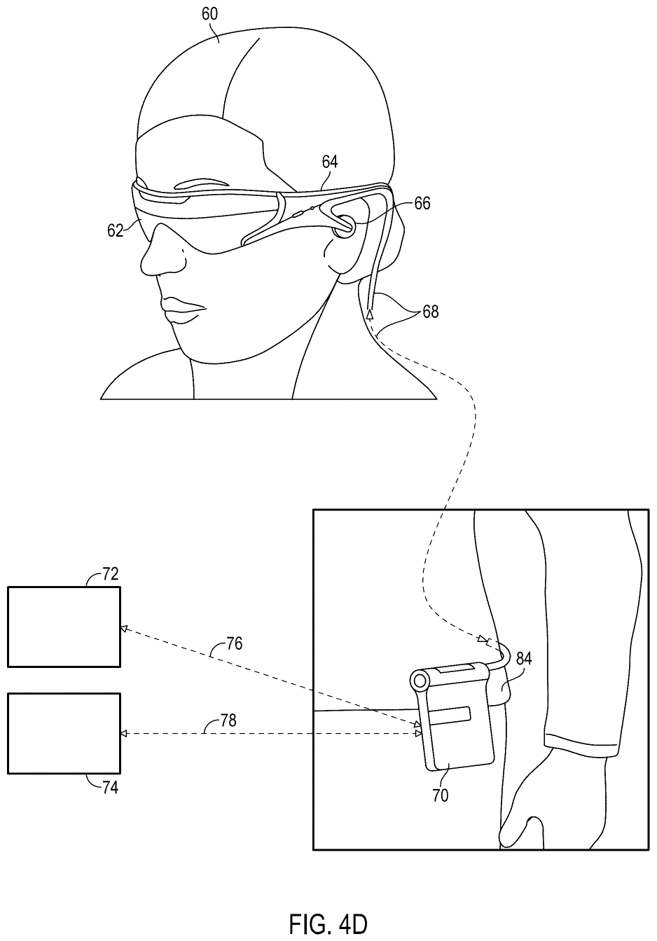

Referring to FIGS. 4A-4D, some general componentry options for an XR system (50) are illustrated according to some embodiments of the invention. In the portions of the detailed description which follow the discussion of FIGS. 4A-4D, various systems, subsystems, and components are presented for addressing the objectives of providing a high-quality, comfortably-perceived display system for a human XR experience.

As shown in FIG. 4A, an XR system user (60) is depicted wearing a frame (64) structure coupled to a display system (62) positioned in front of the eyes of the user. A speaker (66) is coupled to the frame (64) in the depicted configuration and positioned adjacent the ear canal of the user (in one embodiment, another speaker, not shown, is positioned adjacent the other ear canal of the user to provide for stereo/shapeable sound control). The display (62) is operatively coupled via a communication link (68), such as by a wired lead or wireless connectivity, to a local processing and data module (70) which may be mounted in a variety of configurations, such as fixedly attached to the frame (64), fixedly attached to a helmet or hat (80) as shown in the embodiment of FIG. 4B, embedded in headphones, removably attached to the torso (82) of the user (60) in a backpack-style configuration as shown in the embodiment of FIG. 4C, or removably attached to the hip (84) of the user (60) in a belt-coupling style configuration as shown in the embodiment of FIG. 4D.

The local processing and data module (70) may comprise a power-efficient processor or controller, as well as digital memory, such as flash memory, both of which may be utilized to assist in the processing, caching, and storage of data, including data a) captured from sensors which may be operatively coupled to the frame (64), such as image capture devices (such as cameras), microphones, inertial measurement units, accelerometers, compasses, GPS units, radio devices, and/or gyros; and/or b) acquired and/or processed using the remote processing module (72) and/or remote data repository (74), possibly for passage to the display (62) after such processing or retrieval. The local processing and data module (70) may be operatively coupled via communication links (76, 78), such as via wired or wireless communication links, to the remote processing module (72) and remote data repository (74) such that these remote modules (72, 74) are operatively coupled to each other and available as resources to the local processing and data module (70).

In one embodiment, the remote processing module (72) may comprise one or more relatively powerful processors or controllers configured to analyze and process data and/or image information. In one embodiment, the remote data repository (74) may comprise a relatively large-scale digital data storage facility, which may be available through the internet or other networking configuration in a “cloud” resource configuration. In one embodiment, all data is stored and all computation is performed in the local processing and data module, allowing fully autonomous use from any remote modules.

Perceptions of Z-axis difference (i.e., distance straight out from the eye along the optical axis) may be facilitated by using a waveguide in conjunction with a variable focus optical element configuration. Image information from a display may be collimated and injected into a waveguide and distributed in a large exit pupil manner using any suitable substrate-guided optics methods known to those skilled in the art-and then variable focus optical element capability may be utilized to change the focus of the wavefront of light emerging from the waveguide and provide the eye with the perception that the light coming from the waveguide is from a particular focal distance. In other words, since the incoming light has been collimated to avoid challenges in total internal reflection waveguide configurations, it will exit in collimated fashion, requiring a viewer's eye to accommodate to the far point to bring it into focus on the retina, and naturally be interpreted as being from optical infinity-unless some other intervention causes the light to be refocused and perceived as from a different viewing distance; one suitable such intervention is a variable focus lens.

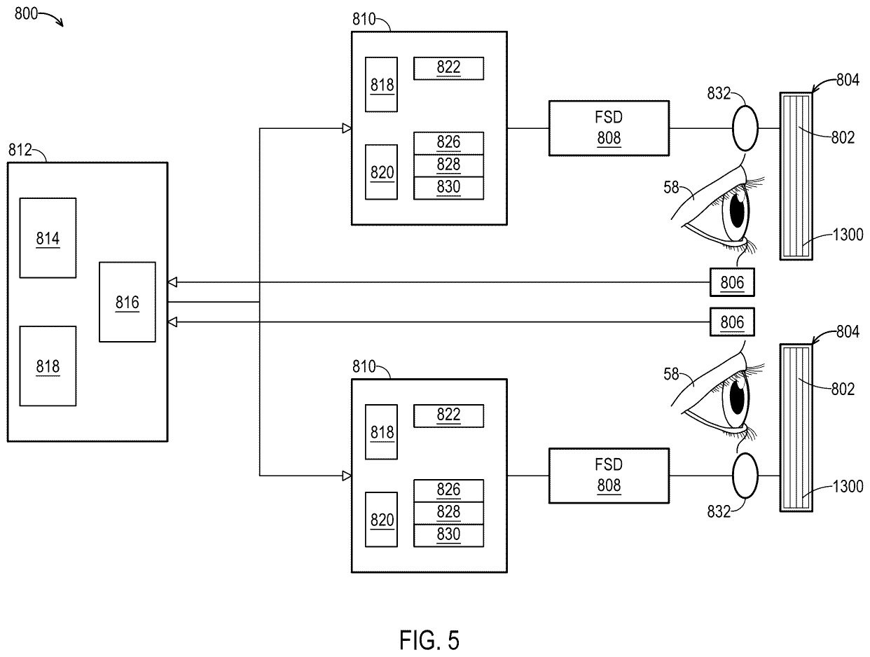

In some embodiments, collimated image information is injected into a piece of glass or other material at an angle such that it totally internally reflects and is passed into the adjacent waveguide. The waveguide may be configured so that the collimated light from the display is distributed to exit somewhat uniformly across the distribution of reflectors or diffractive features along the length of the waveguide. Upon exit toward the eye, the exiting light is passed through a variable focus lens element wherein, depending upon the controlled focus of the variable focus lens element, the light exiting the variable focus lens element and entering the eye will have various levels of focus (a collimated flat wavefront to represent optical infinity, more and more beam divergence/wavefront curvature to represent closer viewing distance relative to the eye (58) (see FIGS. 5-12).

In a “frame sequential” configuration, a stack of sequential two-dimensional images may be fed to the display sequentially to produce three-dimensional perception over time, in a manner akin to the manner in which a computed tomography system uses stacked image slices to represent a three-dimensional structure. A series of two-dimensional image slices may be presented to the eye, each at a different focal distance to the eye, and the eye/brain would integrate such a stack into a perception of a coherent three-dimensional volume. Depending upon the display type, line-by-line, or even pixel-by-pixel sequencing may be conducted to produce the perception of three-dimensional viewing. For example, with a scanned light display (such as a scanning fiber display or scanning mirror display), the display is presenting the waveguide with one line or one pixel at a time in a sequential fashion.

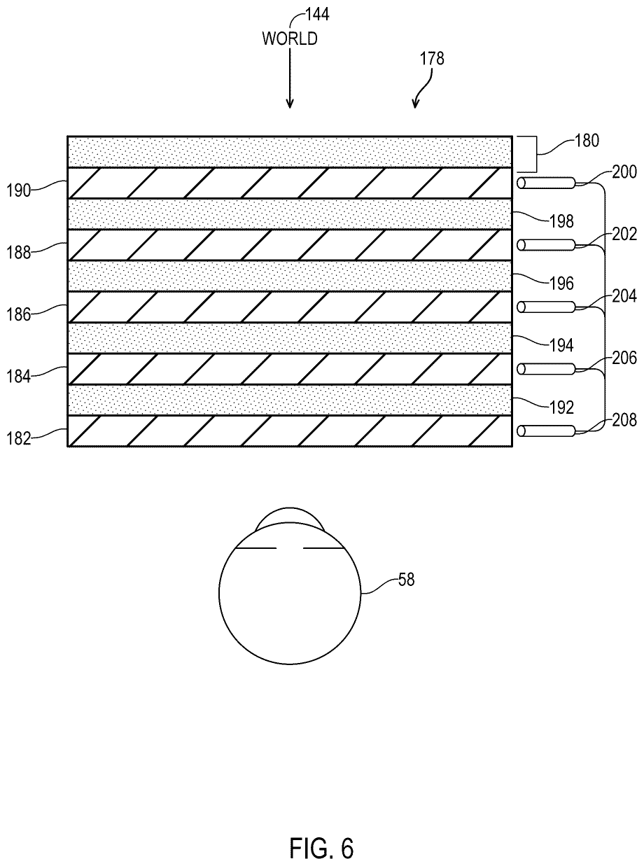

Referring to FIG. 6, a stacked waveguide assembly (178) may be utilized to provide three-dimensional perception to the eye/brain by having a plurality of waveguides (182, 184, 186, 188, 190) and a plurality of weak lenses (198, 196, 194, 192) configured together to send image information to the eye with various levels of wavefront curvature for each waveguide level indicative of focal distance to be perceived for that waveguide level. A plurality of displays (200, 202, 204, 206, 208), or in another embodiment a single multiplexed display, may be utilized to inject collimated image information into the waveguides (182, 184, 186, 188, 190), each of which may be configured, as described above, to distribute incoming light substantially equally across the length of each waveguide, for exit down toward the eye.

The waveguide 182 nearest the eye (58) is configured to deliver collimated light, as injected into such waveguide (182), to the eye (58), which may be representative of the optical infinity focal plane. The next waveguide up (184) is configured to send out collimated light which passes through the first weak lens (192; e.g., a weak negative lens) before it can reach the eye (58). The first weak lens (192) may be configured to create a slight convex wavefront curvature so that the eye/brain interprets light coming from that next waveguide up (184) as coming from a first focal plane closer inward toward the person from optical infinity. Similarly, the third up waveguide (186) passes its output light through both the first (192) and second (194) lenses before reaching the eye (58). The combined optical power of the first (192) and second (194) lenses may be configured to create another incremental amount of wavefront divergence so that the eye/brain interprets light coming from that third waveguide up (186) as coming from a second focal plane even closer inward toward the person from optical infinity than was light from the next waveguide up (184).

The other waveguide layers (188, 190) and weak lenses (196, 198) are similarly configured, with the highest waveguide (190) in the stack sending its output through all of the weak lenses between it and the eye for an aggregate focal power representative of the closest focal plane to the person. To compensate for the stack of lenses (198, 196, 194, 192) when viewing/interpreting light coming from the world (144) on the other side of the stacked waveguide assembly (178), a compensating lens layer (180) is disposed at the top of the stack to compensate for the aggregate power of the lens stack (198, 196, 194, 192) below. Such a configuration provides as many perceived focal planes as there are available waveguide/lens pairings, again with a relatively large exit pupil configuration as described above. Both the reflective aspects of the waveguides and the focusing aspects of the lenses may be static (i.e., not dynamic or electro-active). In an alternative embodiment they may be dynamic using electro-active features as described above, enabling a small number of waveguides to be multiplexed in a time sequential fashion to produce a larger number of effective focal planes.

Various diffraction configurations can be employed for focusing and/or redirecting collimated beams. For example, passing a collimated beam through a linear diffraction pattern, such as a Bragg grating, will deflect, or “steer,” the beam. Passing a collimated beam through a radially symmetric diffraction pattern, or “Fresnel zone plate,” will change the focal point of the beam. A combination diffraction pattern can be employed that has both linear and radial elements which produces both deflection and focusing of a collimated input beam. These deflection and focusing effects can be produced in a reflective as well as transmissive mode.

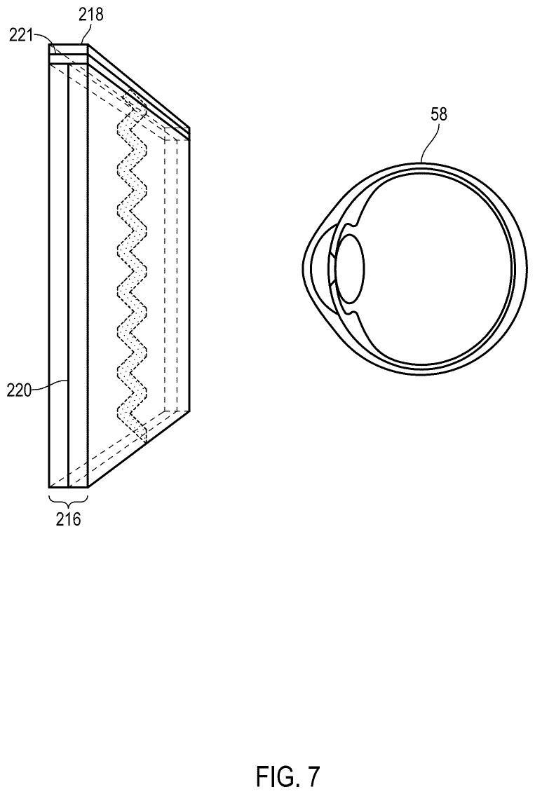

These principles may be applied with waveguide configurations to allow for additional optical system control. As shown in FIG. 7, a diffraction pattern (220), or “diffractive optical element” (or “DOE”) has been embedded within a planar waveguide (216) such that as a collimated beam is totally internally reflected along the planar waveguide (216), it intersects the diffraction pattern (220) at a multiplicity of locations. The structure may also include another waveguide (218) into which the beam may be injected (by a projector or display, for example), with a DOE (221) embedded in this other waveguide (218).

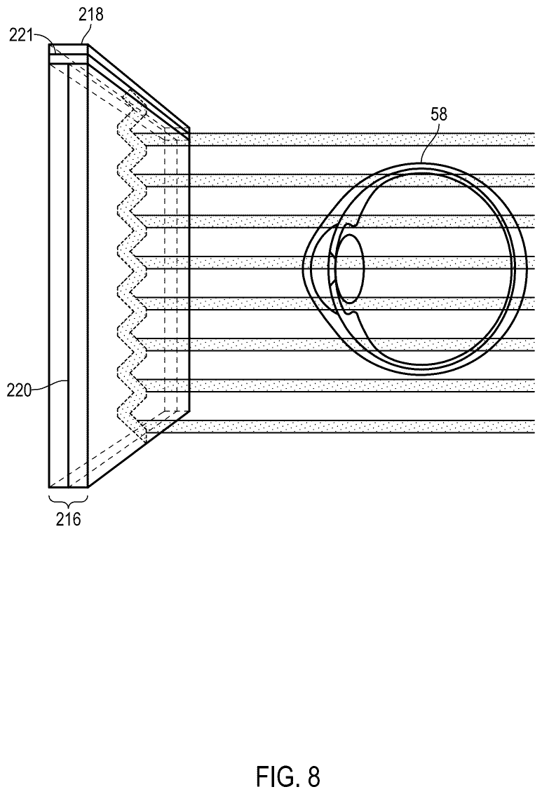

Preferably, the DOE (220) has a relatively low diffraction efficiency so that only a portion of the light of the beam is deflected toward the eye (58) with each intersection of the DOE (220) while the rest continues to move through the planar waveguide (216) via total internal reflection; the light carrying the image information is thus divided into a number of related light beams that exit the waveguide at a multiplicity of locations and the result is a fairly uniform pattern of exit emission toward the eye (58) for this particular collimated beam bouncing around within the planar waveguide (216), as shown in FIG. 8. The exit beams directed toward the eye (58) are shown in FIG. 8 as substantially parallel, because, in this case, the DOE (220) has only a linear diffraction pattern. However, changes to this linear diffraction pattern pitch may be utilized to controllably deflect the exiting parallel beams, thereby producing a scanning or tiling functionality.

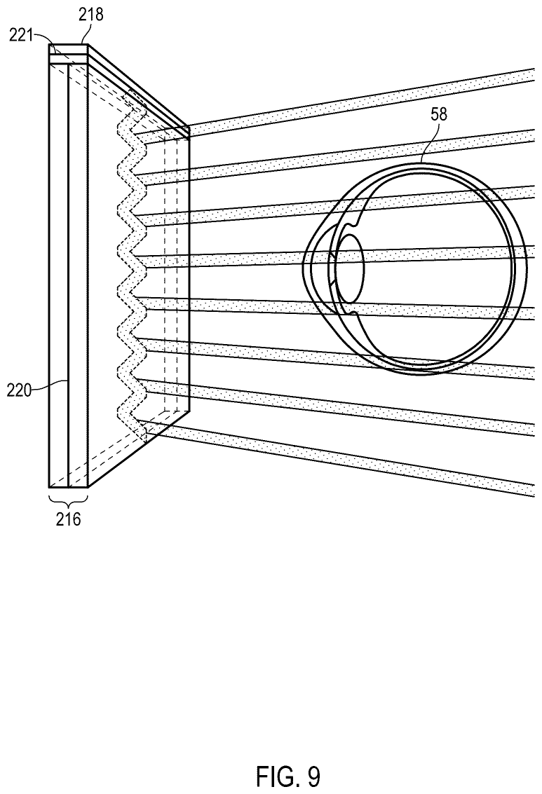

Referring to FIG. 9, with changes in the radially symmetric diffraction pattern component of the embedded DOE (220), the exit beam pattern is more divergent, which would require the eye to accommodate to a closer distance to bring it into focus on the retina and would be interpreted by the brain as light from a viewing distance closer to the eye than optical infinity.

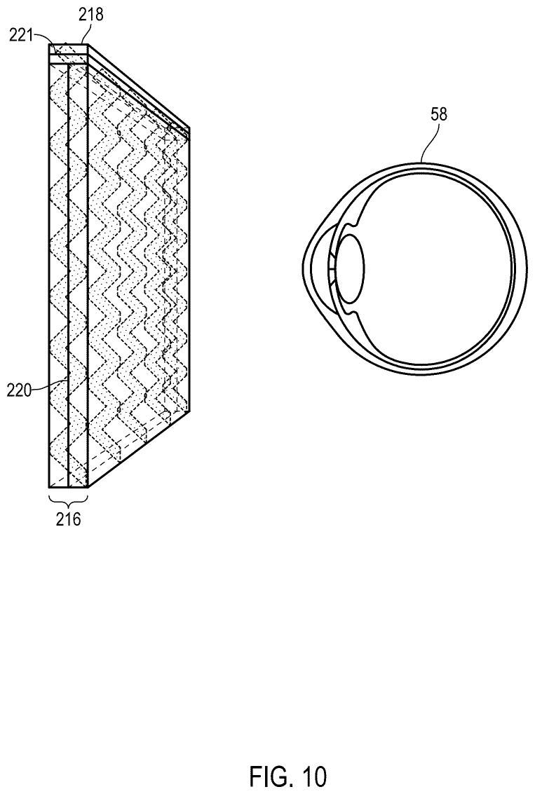

Referring to FIG. 10, with the addition of the other waveguide (218) into which the beam may be injected (by a projector or display, for example), a DOE (221) embedded in this other waveguide (218), such as a linear diffraction pattern, may function to spread the light across the entire larger planar waveguide (216), which functions to provide the eye (58) with a very large incoming field of incoming light that exits from the larger planar waveguide (216), e.g., a large eye box, in accordance with the particular DOE configurations at work.

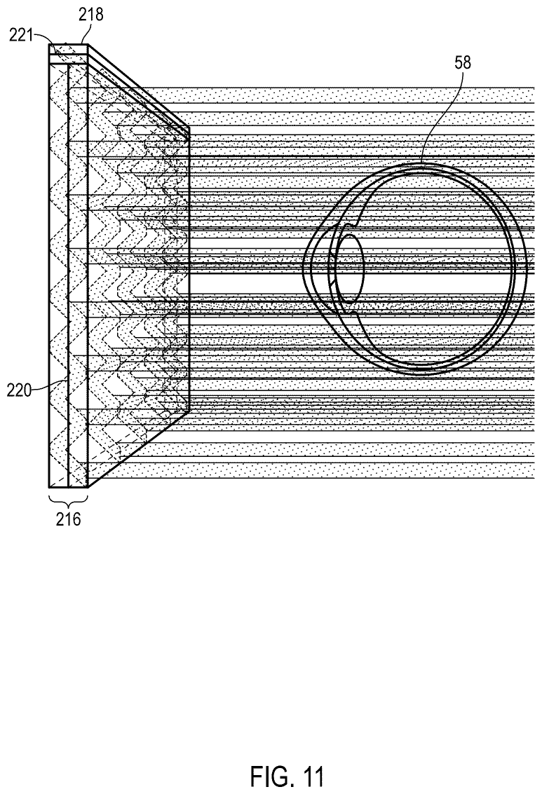

The DOEs (220, 221) are depicted bisecting the associated waveguides (216, 218) but this need not be the case; they could be placed closer to, or upon, either side of either of the waveguides (216, 218) to have the same functionality. Thus, as shown in FIG. 11, with the injection of a single collimated beam, an entire field of cloned collimated beams may be directed toward the eye (58). In addition, with a combined linear diffraction pattern/radially symmetric diffraction pattern scenario such as that discussed above, a beam distribution waveguide optic (for functionality such as exit pupil functional expansion; with a configuration such as that of FIG. 11, the exit pupil can be as large as the optical element itself, which can be a very significant advantage for user comfort and ergonomics) with Z-axis focusing capability presented, in which both the divergence angle of the cloned beams and the wavefront curvature of each beam represent light coming from a point closer than optical infinity.

In one embodiment, one or more DOEs are switchable between “on” states in which they actively diffract, and “off” states in which they do not significantly diffract. For instance, a switchable DOE may comprise a layer of polymer dispersed liquid crystal, in which microdroplets comprise a diffraction pattern in a host medium, and the refractive index of the microdroplets can be switched to substantially match the refractive index of the host material (in which case the pattern does not appreciably diffract incident light) or the microdroplet can be switched to an index that does not match that of the host medium (in which case the pattern actively diffracts incident light). Further, with dynamic changes to the diffraction terms, a beam scanning or tiling functionality may be achieved. As noted above, it is desirable to have a relatively low diffraction grating efficiency in each of the DOEs (220, 221) because it facilitates distribution of the light, and also because light coming through the waveguides that is desirably transmitted (for example, light coming from the world 144 toward the eye 58 in an augmented reality configuration) is less affected when the diffraction efficiency of the DOE that it crosses (220) is lower-so a better view of the real world through such a configuration is achieved.

Configurations such as those illustrated herein preferably are driven with injection of image information in a time sequential approach, with frame sequential driving being the most straightforward to implement. For example, an image of the sky at optical infinity may be injected at time1 and the diffraction grating retaining collimation of light may be utilized. Thereafter, an image of a closer tree branch may be injected at time2 while a DOE controllably imparts a focal change, say one diopter or 1 meter away, to provide the eye/brain with the perception that the branch light information is coming from the closer focal range. This kind of paradigm can be repeated in rapid time sequential fashion such that the eye/brain perceives the input to be all part of the same image. This is just a two focal plane example—preferably the system will include more focal planes to provide a smoother transition between objects and their focal distances. This kind of configuration generally assumes that the DOE is switched at a relatively low speed (i.e., in sync with the frame-rate of the display that is injecting the images—in the range of tens to hundreds of cycles/second).

The opposite extreme may be a configuration wherein DOE elements can shift focus at tens to hundreds of MHz or greater, which facilitates switching of the focus state of the DOE elements on a pixel-by-pixel basis as the pixels are scanned into the eye (58) using a scanned light display type of approach. This is desirable because it means that the overall display frame-rate can be kept quite low; just low enough to make sure that “flicker” is not a problem (in the range of about 60-120 frames/sec).

In between these ranges, if the DOEs can be switched at KHz rates, then on a line-by-line basis the focus on each scan line may be adjusted, which may afford the user with a visible benefit in terms of temporal artifacts during an eye motion relative to the display, for example. For instance, the different focal planes in a scene may, in this manner, be interleaved, to minimize visible artifacts in response to a head motion (as is discussed in greater detail later in this disclosure). A line-by-line focus modulator may be operatively coupled to a line scan display, such as a grating light valve display, in which a linear array of pixels is swept to form an image; and may be operatively coupled to scanned light displays, such as fiber-scanned displays and mirror-scanned light displays.

A stacked configuration, similar to those of FIG. 6, may use dynamic DOEs to provide multi-planar focusing simultaneously. For example, with three simultaneous focal planes, a primary focus plane (based upon measured eye accommodation, for example) could be presented to the user, and a +margin and −margin (i.e., one focal plane closer, one farther out) could be utilized to provide a large focal range in which the user can accommodate before the planes need be updated. This increased focal range can provide a temporal advantage if the user switches to a closer or farther focus (i.e., as determined by accommodation measurement); then the new plane of focus could be made to be the middle depth of focus, with the + and − margins again ready for a fast switchover to either one while the system catches up.

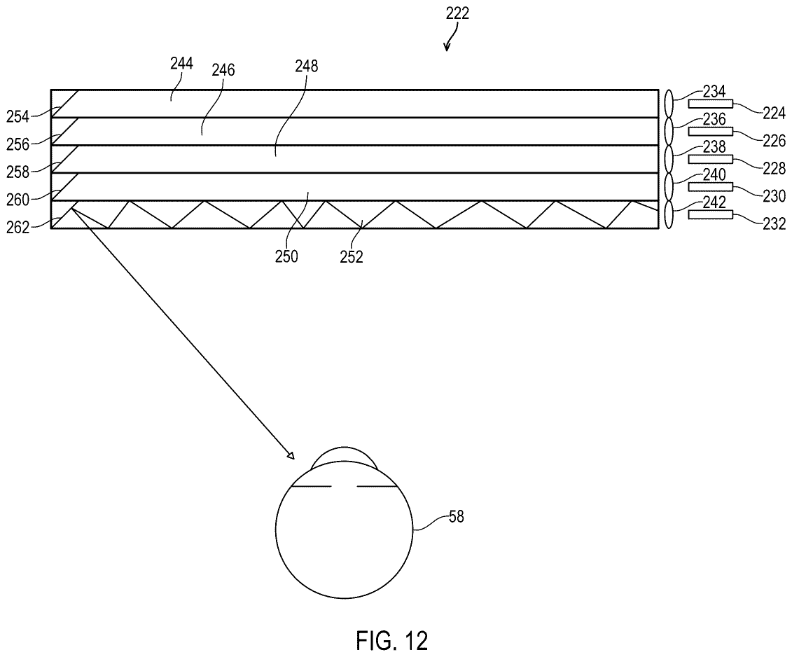

Referring to FIG. 12, a stack (222) of planar waveguides (244, 246, 248, 250, 252) is shown, each having a reflector (254, 256, 258, 260, 262) at the end and being configured such that collimated image information injected in one end by a display (224, 226, 228, 230, 232) bounces by total internal reflection down to the reflector, at which point some or all of the light is reflected out toward an eye or other target. Each of the reflectors may have slightly different angles so that they all reflect exiting light toward a common destination such as a pupil. Lenses (234, 236, 238, 240, 242) may be interposed between the displays and waveguides for beam steering and/or focusing.

As discussed above, an object at optical infinity creates a substantially planar wavefront, while an object closer, such as 1 m away from the eye, creates a curved wavefront (with about 1 m convex radius of curvature). The eye's optical system needs to have enough optical power to bend the incoming rays of light so that they end up focused on the retina (convex wavefront gets turned into concave, and then down to a focal point on the retina). These are basic functions of the eye.

In many of the embodiments described above, light directed to the eye has been treated as being part of one continuous wavefront, some subset of which would hit the pupil of the particular eye. In another approach, light directed to the eye may be effectively discretized or broken down into a plurality of beamlets or individual rays, each of which has a diameter less than about 0.5 mm and a unique propagation pathway as part of a greater aggregated wavefront that may be functionally created with an aggregation of the beamlets or rays. For example, a curved wavefront may be approximated by aggregating a plurality of discrete neighboring collimated beams, each of which is approaching the eye from an appropriate angle to represent a point of origin that matches the center of the radius of curvature of the desired aggregate wavefront.

When the beamlets have a diameter of about 0.5 mm or less, it is as though it is coming through a pinhole lens configuration, which means that each individual beamlet is always in relative focus on the retina, independent of the accommodation state of the eye—however the trajectory of each beamlet will be affected by the accommodation state. For instance, if the beamlets approach the eye in parallel, representing a discretized collimated aggregate wavefront, then an eye that is correctly accommodated to infinity will deflect the beamlets to all converge upon the same shared spot on the retina, and will appear in focus. If the eye accommodates to, say, 1 m, the beams will be converged to a spot in front of the retina, cross paths, and fall on multiple neighboring or partially overlapping spots on the retina—appearing blurred.

If the beamlets approach the eye in a diverging configuration, with a shared point of origin 1 meter from the viewer, then an accommodation of 1 m will steer the beams to a single spot on the retina, and will appear in focus; if the viewer accommodates to infinity, the beamlets will converge to a spot behind the retina, and produce multiple neighboring or partially overlapping spots on the retina, producing a blurred image. Stated more generally, the accommodation of the eye determines the degree of overlap of the spots on the retina, and a given pixel is “in focus” when all of the spots are directed to the same spot on the retina and “defocused” when the spots are offset from one another. This notion that all of the 0.5 mm diameter or less beamlets are always in focus, and that they may be aggregated to be perceived by the eyes/brain as though they are substantially the same as coherent wavefronts, may be utilized in producing configurations for comfortable three-dimensional virtual or augmented reality perception.

In other words, a set of multiple narrow beams may be used to emulate what is going on with a larger diameter variable focus beam, and if the beamlet diameters are kept to a maximum of about 0.5 mm, then they maintain a relatively static focus level, and to produce the perception of out-of-focus when desired, the beamlet angular trajectories may be selected to create an effect much like a larger out-of-focus beam (such a defocusing treatment may not be the same as a Gaussian blur treatment as for the larger beam, but will create a multimodal point spread function that may be interpreted in a similar fashion to a Gaussian blur).

In some embodiments, the beamlets are not mechanically deflected to form this aggregate focus effect, but rather the eye receives a superset of many beamlets that includes both a multiplicity of incident angles and a multiplicity of locations at which the beamlets intersect the pupil; to represent a given pixel from a particular viewing distance, a subset of beamlets from the superset that comprise the appropriate angles of incidence and points of intersection with the pupil (as if they were being emitted from the same shared point of origin in space) are turned on with matching color and intensity, to represent that aggregate wavefront, while beamlets in the superset that are inconsistent with the shared point of origin are not turned on with that color and intensity (but some of them may be turned on with some other color and intensity level to represent, e.g., a different pixel).

Referring now to FIG. 5, an example embodiment of an XR system (800) that uses an improved eyepiece having an improved diffraction structure will now be described. The XR system (800) generally includes an image generating processor (812), at least one FSD (808) (fiber scanning device), FSD circuitry (810), a coupling optic (832), and a pair of eyepieces 804 (one for each eye (58)). Each eyepiece (804) comprises an optics assembly (802) (also referred to as a “DOE assembly (802)”). The DOE assembly (802) includes a plurality of stacked DOEs (1300), having a diffraction structure including a waveguide with the improved diffraction structure, as described herein. The system (800) may also include an eye-tracking subsystem (806). As shown in FIG. 5, the FSD circuitry (810) may comprise circuitry (810) having a maxim chip CPU (818), a temperature sensor (820), a piezo-electrical drive/transducer (822), a red laser (826), a blue laser (828), and a green laser (830) and a fiber combiner that combines all three lasers (826, 828 and 830). FSD circuitry (810) is in communication with the image generation processor (812). It is noted that other types of imaging technologies are also usable instead of FSD devices. For example, high-resolution liquid crystal display (“LCD”) systems, a backlighted ferroelectric panel display, and/or a higher-frequency DLP system may all be used in some embodiments of the invention.

The image generating processor (812) is responsible for generating virtual content to be ultimately displayed to the user. The image generating processor (812) may convert an image or video associated with the virtual content to a format that can be projected to the user in 3D. For example, in generating 3D content, the virtual content may need to be formatted such that portions of a particular image are displayed on a particular depth plane while other portions are displayed at other depth planes. Or, all of the image may be generated at a particular depth plane. Or, the image generating processor (812) may be programmed to feed slightly different images to right and left eye such that when viewed together, the virtual content appears coherent and comfortable to the user's eyes. In one or more embodiments, the image generating processor (812) delivers virtual content to the optics assembly (802) in a time-sequential manner. A first portion of a virtual scene may be delivered first, such that the optics assembly (802) projects the first portion at a first depth plane. Then, the image generating processor (812) may deliver another portion of the same virtual scene such that the optics assembly (802) projects the second portion at a second depth plane and so on. Here, the Alvarez lens assembly may be laterally translated quickly enough to produce multiple lateral translations (corresponding to multiple depth planes) on a frame-to frame basis.

The image generating processor (812) may further include a memory (814), a CPU (818), a GPU (816), and other circuitry for image generation and processing. The image generating processor (812) may be programmed with the desired virtual content to be presented to the user of the XR system (800). It should be appreciated that in some embodiments, the image generating processor may be housed in the wearable XR system. In other embodiments, the image generating processor (812) and other circuitry may be housed in a belt pack that is coupled to the wearable optics.

The XR system (800) also includes coupling optics (832) to direct the light from the FSD (808) to the optics assembly (802). The coupling optics (832) may refer to one or more conventional lenses that are used to direct the light into the DOE assembly (802). The XR system 800 also includes the eye-tracking subsystem (806) that is configured to track the user's eyes and determine the user's focus.

In one or more embodiments, software blurring may be used to induce blurring as part of a virtual scene. A blurring module may be part of the processing circuitry in one or more embodiments. The blurring module may blur portions of one or more frames of image data being fed into the DOE. In such an embodiment, the blurring module may blur out parts of the frame that are not meant to be rendered at a particular depth frame. Example approaches that can be used to implement the above image display systems, and components therein, are described in U.S. Utility patent application Ser. No. 14/555,585 filed on Nov. 27, 2014, which is incorporated by reference herein in its entirety.

### New Stacked Waveguide Assembly Design With Improved Edge Blackening

As described above, an eyepiece (EP) (e.g., an optics assembly (802)) of an XR display system (800) comprises a stacked waveguide assembly (1300) comprising a stack of a plurality of waveguides. As described herein, one or more of the waveguides may have a diffraction pattern formed onto the waveguide, such that as a collimated beam is totally internally reflected along the waveguide, the beam intersects the diffraction pattern at a multiplicity of locations. This stacked waveguide arrangement can provide image objects at multiple focal planes within a stereoscopic 3-D simulation display system according to some embodiments of the invention.

In general, eyepiece stacks, which have active waveguide layers and cover layers, need edge blackening as well as good stack mechanical stability in order for high contrast virtual images to be reliably generated from EP stacks. Existing waveguide stacks have used at least one blackened adhesive to bond the waveguides together into a waveguide stack, which can be hard to cure and typically do not do an adequate job absorbing light to give the best possible contrast. Disclosed herein are new designs for, and methods of making, a waveguide stack having an improved edge blackening combination for active layers that includes a thin layer of carbon black pigment applied onto and around the edges of the waveguide layers with use of an optional filler based adhesive, and with and without additional color absorbing pigment / dye in the adhesive on the exterior of the edge blackening to bond the active layer to other active layers and/or the cover layers. The improved edge blackened waveguide stack improves optical virtual image contrast by making sure as much of the light bouncing off the edges of the eyepiece waveguide is absorbed, as opposed to being propagated through total internal reflection (TIR). The architecture disclosed herein may use a fast drying pigmented carbon black ink applied at the edges of the singulated waveguide cut to shape either before or after the stack lamination with either a clear or a color-absorbing adhesive. This new edge blackened stack can then be perimeter bonded to a frame with a clear or a color-absorbing adhesive.

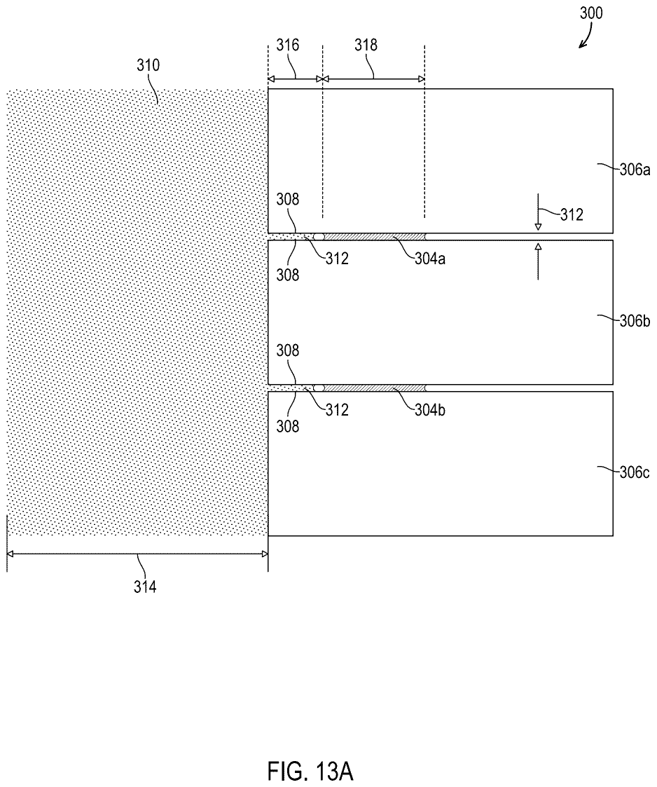

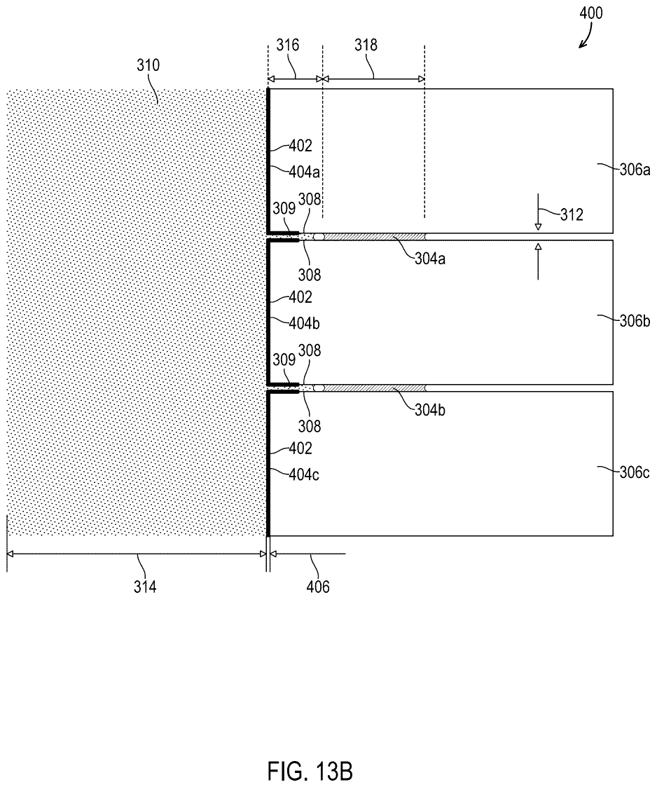

FIGS. 13A and 13B illustrate a comparison of existing waveguide stack bonding architecture 300 (see FIG. 13A) to the improved edge blackening and stack bonding architecture 400 disclosed herein (see FIG. 13B). As shown in FIG. 13A, the existing waveguide stack bonding architecture 300 includes a stack adhesive (304a, 304b) between each waveguide (306a, 306b, 306c) forming a stack gap 312 between adjacent waveguides (306) and an edge gap surface (308) between the stack adhesive (304) and the edge of the waveguides 306. The opposing edge gap surfaces (308) of each waveguide (306) form an edge gap (309) (i.e., the gap between opposing edge gap surfaces (308) extending from the internal edge of the waveguides (306) to the edge of stack adhesive (304)). The edge gap (309) may extend an average length (316) of about 0.21 mm from the edge of the waveguides 306. The stack adhesive (304) may have an average length (318) of about 0.91 mm along the stack gap (312). The stack gap (312) may have a thickness (312) of about 30-50 μm. The waveguide stack 300 is bonded to a frame (e.g., a frame same or similar to frame (64) shown in FIG. 4A, or other metal frame) of an XR headset or XR eyeglasses (also referred to as an eyepiece) using a perimeter bond. The perimeter bond (310) may have a thickness (314) of about 800 μm. As shown in FIG. 13A, the perimeter bond (310) tends to wick into the edge gap (312) between adjacent waveguides (306).

In comparison, the improved waveguide stack (400) shown in FIG. 13B includes an edge blackening (402) on the external edge (404) of each waveguide (306). The edge blackening (402) (also referred to as blackening edge layer 402) typically has a thickness of less than 1 μm. The edge blackening (402) may extend onto the edge gap surface (308) of each waveguide (306) forming the edge gap 309 between adjacent waveguides (306), as shown in FIG. 13B. The perimeter bond (310) is then applied over the edge blackening (402) to bond the waveguide stack (400) to a frame (e.g., a frame same or similar to frame (64) shown in FIG. 4A, or other metal frame) of an XR headset or XR eyeglasses.

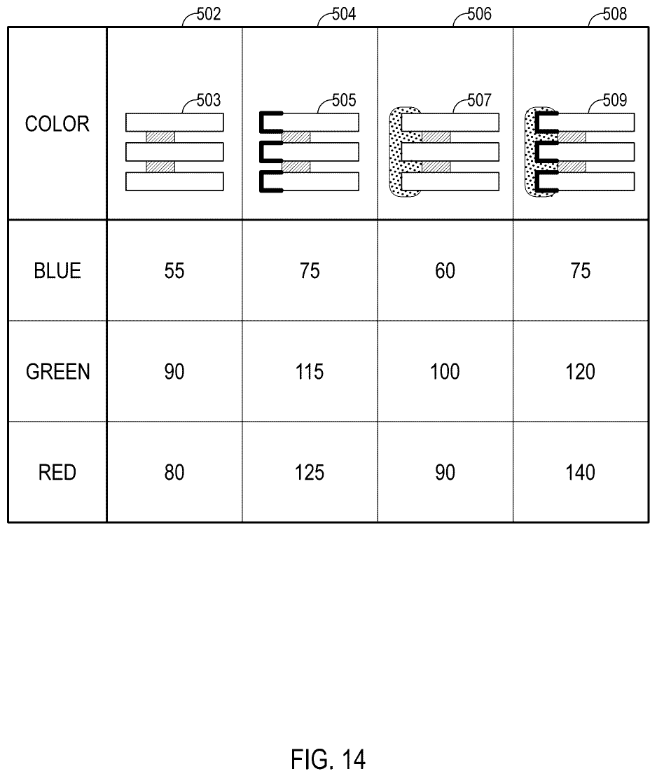

FIG. 14 is a table showing a comparison of the Image ANSI contrast from an RGB (red, green blue) stack for each R G B color waveguide for various stack architectures. The first column (502) from the left shows the Image ANSI contrast for each R G B color waveguide for a waveguide stack (503) (shown schematically) having only stack adhesive (304) bonding the waveguides (306) together. The second column (504) from the left shows the Image ANSI contrast for each R G B color waveguide for a waveguide stack (505) (shown schematically) having stack adhesive 304 bonding the waveguides (306) together and edge black ink (402) on the external edge of each waveguide. The third column (506) from the left shows the Image ANSI contrast for each R G B color waveguide for a waveguide stack (507) (shown schematically) having stack adhesive bonding the waveguides together and perimeter bond on the external edge of the waveguide stack, without edge blackening. The fourth column (508) from the left shows the Image ANSI contrast for each R G B color waveguide for a waveguide stack (509) (shown schematically) having stack adhesive (304) bonding the waveguides (306), edge black ink (402) on the external edge (404) of each waveguide, and perimeter bond (310) (with color absorbing material) applied over the edge black ink (402) on the external edge (404) of the waveguide stack (509). The table of FIG. 14 shows that the edge blackening waveguide stack designs (505, 509) (second column (504) and fourth column (508) from the left) disclosed herein have improved Image ANSI contrast (i.e., higher Image ANSI contrast) without affecting image sharpness over previous stack designs (first column (502) and third column (506) from the left). As shown in the fourth column (508) of the table of FIG. 14, the perimeter bond (310) having a color absorbing material further improves the absorption of light bouncing off the edges of the eyepiece waveguide, thereby improving the Image ANSI contrast, as compared to the edge blackening alone as shown in the second column (505).

The blackening edge (402), such as blackening ink, applied to the edges (404) of the singulated or stacked eyepiece waveguide (400) (with or without a blank cover layer (e.g., a perimeter bond (310)) at the outer stack surfaces) can be applied at the edges (404) using a roller tip, brush tip, micro gravure, spray/atomization etc. The blackening agent (402) can be carbon black pigments as small as 30 nm in diameter applied using a fast drying surfactant such as methanol, ethanol, isopropanol, etc. The blackening pigment can also comprise of a mixture of various pigment or dyes which can block varying wavelengths of light where the sum of all the color blocking agents block light from 400 nm to 800 nm wavelengths. Suitable dyes and pigments include, for example, Carbon black (size range 5 nm˜500 nm), Rhodamine B, Tartarzine, chemical dyes from Yamada Chemical Co., Ltd., powdered coating pigments such as SUNFAST™ powder coating pigments from SunChemical Corp. (e.g., Green 36, Blue, Violet 23, etc.).

The stack adhesive material (304) and the perimeter bond (310) can be a pre-polymer material which can be dispensed using inkjetting, syringe pump, spray/atomization, etc. The pre-polymer material can include a resin material, such as an epoxy vinyl ester. The color-absorbing resin can include UV and thermally curable crosslinking monomers and oligomers, with or without oxygen inhibitors. To make the color-absorbing resin, dye or pigment is typically premixed with solvent and resin, and a photo initiator is added to yield the UV curable resin. The dye or pigment can be selected to absorb all or a portion of light in the visible region. In some examples, the dye or pigment is black (i.e., absorbs all visible wavelengths). In other examples, the dye or pigment is blue (i.e., absorbs green and red wavelengths), green (i.e., absorbs blue and red wavelengths), red (i.e., absorbs blue and green wavelengths), or any combination thereof. In particular, a color-absorbing region can include a combination of red, green, and blue dye or pigmented polymer that is not black, but all absorbs wavelength ranges of visible light that is incident on the waveguide.

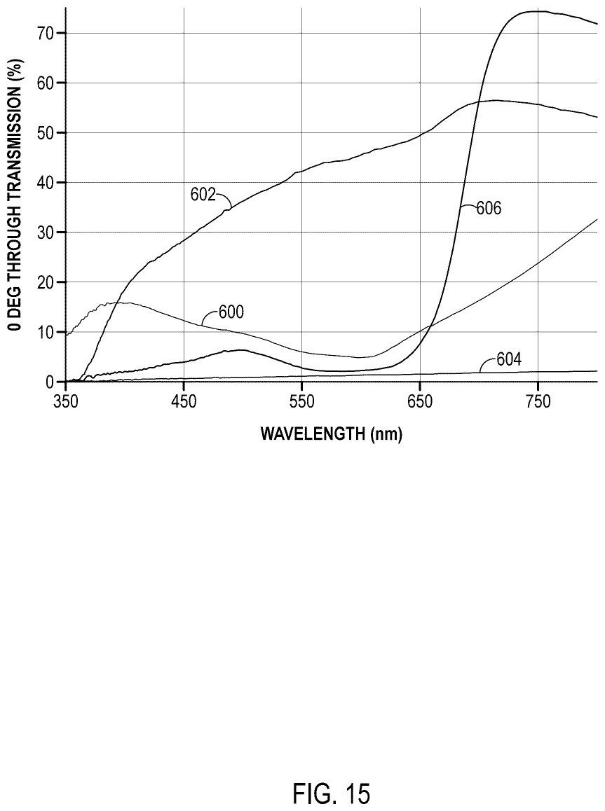

FIG. 15 shows examples of transmission curves of the visible spectrum at 0 degrees incidence for four different types of adhesives used for the stack adhesive material (304) and perimeter bond (310). The line (600) is the transmission curve for a 1 μm thick black ink layer, and lines (602, 604 and 606) are respective transmission curves for three different types of a 30 um thick layer of color absorbing rich dye-pigment UV/Thermally crosslinkable adhesives. FIG. 15 illustrates how much more light a 1 μm thick black ink applied layer blocks compared to even up to 30 μm of a resin crosslinked dye-pigment adhesive layer.

The pre-polymer resin can include a vinyl monomer (e.g., methyl metacrylate) and/or difunctional or trifunctional vinyl monomers (e.g., diacrylates, triacrylates, dimethacrylates, etc.), with or without aromatic molecules in the monomer. The pre-polymer material can include a monomer having one or more functional groups such as alkyl, carboxyl, carbonyl, hydroxyl, and/or alkoxy. Sulfur atoms and aromatic groups, which both have higher polarizability, can be incorporated into these acrylate components to boost the refractive index of the formulation and generally have a refractive index ranging from 1.5˜1.75. In some implementations, the pre-polymer material can include a cyclic aliphatic epoxy containing resin and can be cured using ultraviolet light and/or heat. In addition, the pre-polymer material can include an ultraviolet cationic photoinitiator and a co-reactant to facilitate efficient ultraviolet curing in ambient conditions.

Incorporating inorganic nanoparticles (NP) as ZrO2 and TiO2 into such imprintable resin polymers can boost refractive index significantly further up to 2.1. Pure ZrO2 and TiO2 crystals can reach 2.2 and 2.4-2.6 index at 532 nm respectively. For the preparation of optical nanocomposites of acrylate monomer and inorganic nanoparticle, the particle size is smaller than 10 nm to avoid excessive Rayleigh scattering. Due to its high specific surface area, high polarity, and incompatibility with the cross-linked polymer matrix, a ZrO2 NP has a tendency to agglomerate in the polymer matrix. Surface modification of NPs can be used to overcome this problem. In this technique, the hydrophilic surface of ZrO2 is modified to be compatible with organics, thus enabling the NP to be uniformly mixed with the polymer. Such modification can be done with silane and carboxylic acid containing capping agents. One end of the capping agent is bonded to ZrO2 surface; the other end of capping agent either contains a functional group that can participate in acrylate crosslinking or a non-functional organic moiety. Examples of surface modified sub-10nm ZrO2 particles are those supplied by PIXELLIGENT TECHNOLOGIES™ and CERION ADVANCED MATERIALS™. These functionalized nanoparticles are typically sold uniformly suspended in solvent as uniform blends, which can be combined with other base materials to yield resist formulations with jettable viscosity and increased refractive index. At times having a higher index at the cured polymer interface can improve light coupling into the color absorbing spacer material, thus removing any scatter-based artifacts of internally replicating light in TIR in the waveguide.

Ultraviolet (UV) acrylate coatings and films tend to suffer from oxygen inhibition during ambient curing. During curing, oxygen will react with acrylate radicals at the surface to generate peroxide radicals, which are inactive. This will effectively stop the chain reaction and result in a sticky, wet surface after UV exposure, which is not desirable. Viscosity of the material can be in a range of about 10 cPs to about 100,000 cPs to about 500,000 cPs. Suitable dyes and pigments include, for example, Carbon black (size range 5 nm˜500 nm), Rhodamine B, Tartarzine, chemical dyes from Yamada Chemical Co., Ltd., and powdered coating pigments such as SUNFAST™ pigments from SunChemical Corp. (e.g., Green 36, Blue, Violet 23, etc.).

The dye or pigment is combined with a solvent and then combined with a UV curable resin to yield a color-absorbing resin. The solvent can be a volatile solvent, such as an alcohol (methanol, ethanol, butanol, or the like) or other less volatile organic solvents, such as dimethylsulfoxide (DMSO), propylene glycol monomethyl ether acetate (PGMEA), toluene, and the like. The dye or pigment can be separated from the solvent or concentrated (e.g., using centrifuge evaporation) to yield an optimal concentration with the crosslinking organic resin (e.g., a UV curable highly transparent material). An optimal concentration of the dye or pigment can impart a color-absorbing film with desirable optical characteristics, such as a greater concentration of color-absorbing dye or pigment, and yield less reflective films. Note that although color absorbing adhesives can be preferred to absorb unwanted light in TIR at the edges of the waveguide eyepiece, when using the Black Ink at the edges of the eyepiece as shown in FIGS. 13A and 14, clear UV/Thermal curable adhesives can also be used.

Compared to conventional water and solvent borne coatings, UV radiation curable coatings and adhesives hold additional challenges for balancing acceptable viscosity for the specific application, targeted gloss level, and desired film properties (e.g. scratch resistance, hardness, adhesion strength, etc.). Due to solvent evaporation, conventional coatings start to orientate and “concentrate” the matting agent during physical drying of the film. As volatile compounds evaporate, the applied film starts to shrink. This shrinkage can vary between 30% up to 60% of the wet films volume depending on volume solids. Compared to this, 100% UV coatings only shrink about 10% during the rapid cure cycle which will result in much less dense packing of matting agent. Extra care need to be taken for matting agent particle size and loading selection and film thickness control in order to achieve good matting performance. Silica based matting agents are effective in reducing the glossiness by introducing surface roughness and wrinkling. Examples of silica matting agents are those from Evonik Corp.:
ACEMATT™ HK 400, D50 particle size of 6.3 um
ACEMATT™ OK 607, D50 particle size of 4.4 um
ACEMATT™ OK 412, D50 particle size of 6.3 um
ACEMATT™ 3600, D50 particle size of 5.0 um

In addition to the surface roughening approach via inorganic particle, organic component can be added to boost internal light scattering to further increase the matting performance. One of this type of components is EBECRYL® 898 radiation curable resin from Allnex Company. To increase opaqueness of coating and adhesive against visible light, broadband absorber such as carbon black pigment can be added in combination of matting agent to achieve bulk darkness and flat surface finish simultaneously. The loading percentage of the pigment can range from 0.2% to 15% by weight depend on curing thickness requirement. To achieve ultra-darkness at 10-20 micron thickness, 10% pigment can be added for example. To minimize oxygen inhibition and enhance surface cure in the air, oxygen scavenger and chain transfer agent such as primary, secondary and tertiary thiols and amines can be added.

Crosslinking the pre-polymer material includes exposing the pre-polymer to actinic radiation having a wavelength between 310 nm and 410 nm and an intensity between 0.1 J/cm2 and 100 J/cm2 . The method can further include, while exposing the pre-polymer to actinic radiation, applying heat of the pre-polymer to a temperature between 40° C. and 120° C.

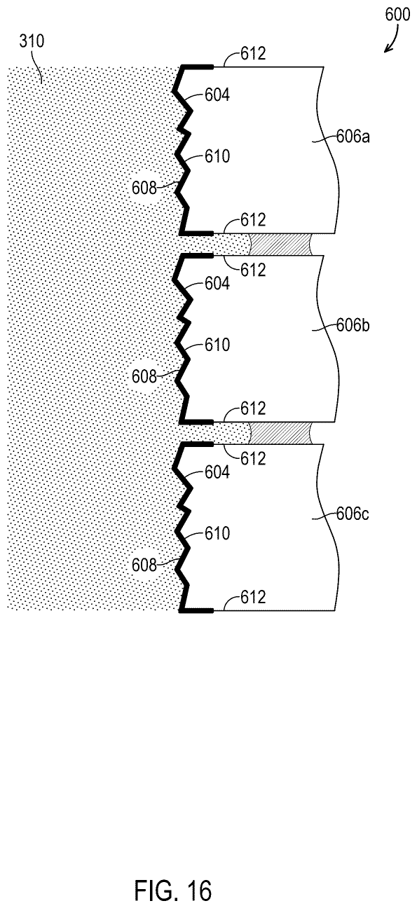

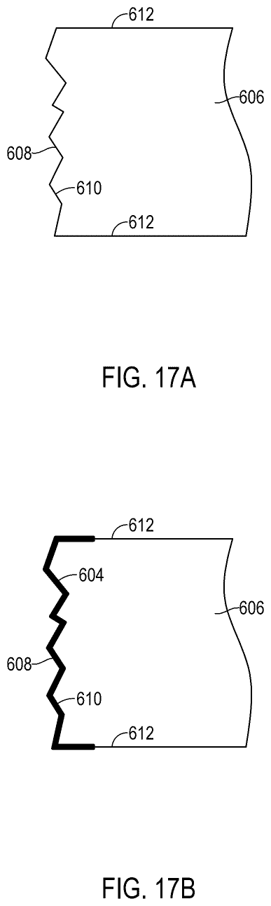

Turning now to FIGS. 16-19, the stacked waveguide assembly (600) may comprise waveguides (600a, 606b, 606c) having roughened edge surfaces (608). The stacked waveguide assembly (600) shown in FIG. 16 is the same as the stacked waveguide assembly (400) shown in FIG. 13B, except that that the plurality of waveguides have one or more edge surface(s) which are roughened and the edge blackening is applied onto the roughened edge surface(s), as described above. In the embodiment shown in FIG. 16, only the external edge surface (610) of the waveguides (606) is roughened where the edge blackening on the external edge surface is applied. FIG. 17A shows one of the waveguides (606) of the stacked waveguide assembly (600) of FIG. 16 with the external edge (610) roughened. The edge blackening (604) is then applied onto the roughened external edge (608) as shown in FIG. 17B.

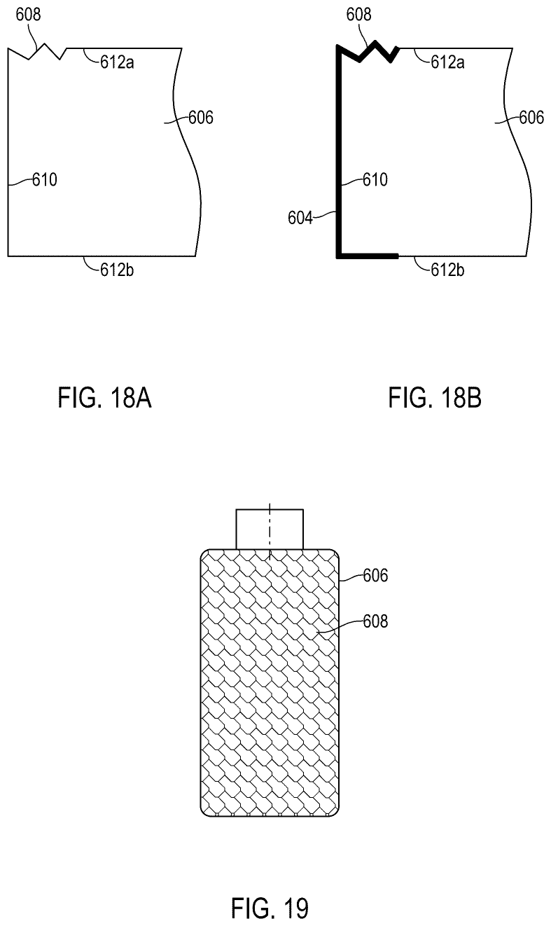

The top and bottom edge gap surfaces (612a, 612b) where the edge blackening (604) is applied may also be roughened, as depicted in FIGS. 18A and 18B. FIGS. 18A and 18B illustrate that the roughened surface (608) may extend onto the top edge gap surface 612a (i.e., edge portion of the top surface) of the waveguide (606). This may be in addition to the surface roughening on the external edge (610) of the waveguide (606). FIG. 18A shows the roughening on the top edge gap surface (612a) of the waveguide (606). FIG. 18B shows the edge blackening (604) applied onto the external edge surface (610) and the roughened top edge gap surface (612a) of the waveguide (606). The bottom edge gap surface (612b) and/or external edge surface (610) may also be roughened where the edge blackening 604 is applied.

The roughening on the edge surfaces (610 and/or 612) of the waveguide (606) where the edge blackening (604) is applied helps increase the surface to volume ratio and thus ability for the color absorbing material to absorb more angles of light. The roughened surfaces (608) may be formed by grinding or rubbing the surfaces against a rough surface to create random or symmetrically patterned (i.e., patterned) features into the surfaces. The roughened surfaces (608) may also be formed by any other suitable manner, such as molding, stamping, forging, or etching the roughened surface into the respective surfaces.

FIG. 19 depicts a magnified view of a portion of the roughened surfaces (608) of the waveguides of FIGS. 16-18B. The roughened surfaces (608) may be formed by grinding or rubbing the surfaces against a rough surface to create random or symmetrically patterned features into the surfaces.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

Various example embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Example aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

The above description of illustrated embodiments is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other devices that implement virtual or AR or hybrid systems and/or which employ user interfaces, not necessarily the example AR systems generally described above.

For instance, the foregoing detailed description has set forth various embodiments of the devices and/or processes via the use of block diagrams, schematics, and examples. As far as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof.

In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any computer-readable medium for use by or in connection with any processor-related system or method. In the context of this disclosure, a memory is a computer-readable medium that is an electronic, magnetic, optical, or other physical device or means that contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other nontransitory media.

Any of the methods described herein can be performed with variations. For example, many of the methods may include additional acts, omit some acts, and/or perform acts in a different order than as illustrated or described.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

Moreover, the various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A stacked waveguide assembly for an eyepiece for use with an XR display system, comprising:
a plurality of waveguides stacked together and configured to transmit image information to a user's eye, each of the waveguides bonded to adjacent waveguides using a stack adhesive applied between the adjacent waveguides proximate an edge of each waveguide; and
a thin blackening edge layer applied onto the edge of each waveguide and configured to absorb substantially all visible light bouncing off the edge of each respective waveguide.

2. The stacked waveguide assembly of claim 1 further comprising a perimeter bond applied over the blackening edge layer.

3. The stacked waveguide assembly of claim 2, wherein the perimeter bond adheres the stacked waveguide assembly bond to a frame of an eyepiece for use with an XR display system.

4. The stacked waveguide assembly of claim 2, wherein, the perimeter bond comprises a color-absorbing adhesive.

5. The stacked waveguide assembly of claim 1, wherein the blackening edge layer comprises carbon black pigments.

6. The stacked waveguide assembly of claim 5, wherein the carbon black pigments are 30 nm in diameter or less.

7. The stacked waveguide assembly of claim 1, wherein the blackening edge layer comprises a dye or pigment selected from the group consisting of: Carbon black having a size range 5 nm˜500 nm; Rhodamine B chemical dye; Tartarzine chemical dye; and powder coating pigments comprising green blue and violet pigments.

8. The stacked waveguide assembly of claim 1, wherein the stack adhesive comprises a color-absorbing adhesive.

9. The stacked waveguide assembly of claim 8, wherein the stack adhesive and/or perimeter bond comprises a pre-polymer material which dispensable using at least one of inkjetting, a syringe pump, or spray atomization, and the pre-polymer material comprises dye or pigment selected to absorb all or a selected portion of visible light.

10. The stacked waveguide assembly of claim 1, wherein at least a portion of the edge where the blackening edge layer is applied has a roughened surface.

11. A method of making a stacked waveguide assembly for an eyepiece for use with an XR display system, the method comprising:
stacking together a plurality of waveguides such that the stacked waveguides are configured to transmit image information to a user's eye;
bonding each of the waveguides to adjacent waveguides using a stack adhesive applied between the adjacent waveguides proximate an edge of the waveguides; and
applying a thin blackening edge layer around the edge of each waveguide such that the blackening edge layer absorbs substantially all visible light bouncing off the edge of each respective waveguide.

12. The method of claim 11, further comprising:
applying a perimeter bond over the blackening edge layer.

13. The method of claim 12, wherein the perimeter bond adheres the stacked waveguide assembly bond to a frame of an eyepiece for use with an XR display system.

14. The method of claim 12, wherein, the perimeter bond comprises a color-absorbing adhesive.

15. The method of claim 11, wherein the blackening edge layer comprises carbon black pigments.

16. The method of claim 15, wherein the carbon black pigments are 30 nm in diameter or less.

17. The method of claim 11, wherein the blackening edge layer comprises a dye or pigment selected from the group consisting of: Carbon black having a size range 5 nm˜500 nm; Rhodamine B chemical dye; Tartarzine chemical dye; and powder coating pigments comprising green blue and violet pigments.

18. The method of claim 11, wherein the stack adhesive comprises a color-absorbing adhesive.

19. The method of claim 18, wherein the stack adhesive and/or perimeter bond comprises a pre-polymer material and the stack adhesive and/or perimeter bond is dispensed using at least one of inkjetting, a syringe pump, or spray atomization, and the pre-polymer material comprises dye or pigment selected to absorb all or a selected portion of visible light.

20. The method of any of claim 11, wherein at least a portion of the edge where the blackening edge layer is applied has a roughened surface.

21. (canceled)

22. (canceled)

23. (canceled)
